(19) United States
(12) Patent Application Publication
(10) Pub. No.: US 2005/0032997 A1
(43) Pub. Date: Feb. 10, 2005

(54) Low polydispersity resin, and preparation thereof

(76) Inventors: Ting-Yu Lee, Kaohsiung (TW); Choa-Ying Yu, Kaohsiung City (TW); Meei-Yu Hsu, Kaohsiung (TW); Shian-Jy Wang, Jhudong Township (TW); Ching Ting, Hsinchu (TW); Kuo-Chen Shih, Kaohsiung (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/714,052

(22) Filed: Nov. 14, 2003

(30) Foreign Application Priority Data
Aug. 5, 2003 (TW) 92121346

(51) Int. Cl. C08F 2/00

(52) U.S. Cl. 526/223; 526/319; 526/227

(57) ABSTRACT

A resin with low polydispersity index and a process for preparing the same. The process includes polymerizing at least one monomer with an initiator and a chain transfer reagent, wherein the monomer is an acrylate monomer having at least one ethylenically unsaturated bonds or norbornene derivatives. Furthermore, a photoresist composition containing the resin composition according to the present invention can increase pattern resolution in lithography process.

### BACKGROUND OF THE INVENTION

1. Field of the Invention

The present invention relates to a low polydispersity resin and preparation thereof, and more particularly to a resin and preparation thereof for photoresist composition.

2. Description of the Related Art

As semiconductor devices are scaled down, lithography is needed for higher integration with device design. Photoresist is an important determiner of smaller line width and design of semiconductor process.

For application to denser integration and multilayer of circuit devices, photoresists in present use are limited to high integration and multilayer application. The main constituents of photoresist for lithography in semiconductor comprise sensitizer, resin, and solvent, and further comprise traces of dissolution inhibitor, antioxidant, thermo-stabilizer, light stabilizer, lubricant, defoamer, planarization reagent, filler, thickener, or other reagents as needed. Photoresist properties include adhesion with semiconductor substrate, pattern completeness, etch resistance, and resolution, depending on resin components.

Resin polydispersity index (PDI) is defined as the ratio of the weight average molecular weight to number average molecular weight (Mw/Mn), wherein the lower the PDI, the narrower the resin molecular weight range. Photoresist with resin with lowered PDI has better performance in lithography and etching for semiconductor fabrication. However, photoresist resins in present use are generally prepared by conventional free radicals polymerization. U.S. Ser. No. 20020031719 discloses a resin composition fabrication method for photoresist, but the resin molecular weight cannot be controlled effectively, such that the resin molecular weight range is wider (PDI is around 2˜3.5). Therefore, the performance of photoresist with the conventional resin is affected, decreasing high resolution semiconductor fabrication stability.

### SUMMARY OF THE INVENTION

Accordingly, an object of the present invention is to provide a resin with lowered PDI. The present invention not only uses free radical initiators to polymerize monomers, but also chain transfer reagents to control free radical polymerization. Resin quality is tuned by effective and precise resin molecular weight and PDI control, and PDI thereof is lowered. As a result, the performance of photoresist with resin with lower PDI is improved.

Another object of the present invention is to provide a preparation process method of resin with lowered PDI.

To achieve these objects, the resin with lowered PDI according to the present invention comprises products provided by at least one reactive monomer, at least one initiator and at least one chain transfer reagent via polymerization.

In the present invention, the at least one reactive monomer can be either homo-monomer or at least two hetero-monomers.

According to one aspect of the present invention, the at least one reactive monomer can be acrylate, derivatives of acrylate or combinations thereof. In the present invention, the term “derivative” referres to a compound main chain having substituent side chains, such as, but not limited to, alkyl group, alkoxy group, phenyl group, phenoxy group, heterocyclic group, cyano group, a halogen atom, trifluoromethyl group, silyl group, and the like.

In another aspect of the invention, the at least one reactive monomer can be norbornene, derivatives of norbornene or combinations thereof.

In still another aspect of the invention, the at least one reactive monomer comprises at least one norbornene and derivatives thereof in a ratio from 1 PPM to 100 wt %, and at least one acrylate and derivatives thereof in a ratio from 0 wt % to 99.99999 wt %, based on the weight of at least one reactive monomer.

In yet another aspect of the invention, the at least one reactive monomer comprises at least one acrylate and derivatives thereof, and at least one norbornene and derivatives thereof simultaneously.

To achieve another object of the present invention, the present invention also provides a preparation process for resin with lowered PDI. The preparation provides at least one reactive monomer to react with at least one initiator and at least one chain transfer reagent to undergo polymerization, wherein the at least one reactive monomer can be acrylate and derivatives thereof, norborene and derivatives thereof, or combinations thereof.

According to the preparation of the present invention, the polydispersity index of resin product is 1.5 or less, and the average molecular weight thereof can be from 2000 to 30000.

In addition, the resins with lowered PDI according to the present invention can be serving as components of a photoresist composition. When the resins according to the present invention serving as components of the photoresist composition have the average molecular weight from 3000 to 25000, the photoresist performance is further improved.

In order to understand the above and other objects, characteristics and advantages, the preferred embodiments and comparative embodiments of the present invention are now detailed described.

### DETAILED DESCRIPTION OF THE INVENTION

The resin with lowered PDI according to the present invention comprises products provided by at least one reactive monomer, at least one initiator and at least one chain transfer reagent via polymerization

In the present invention, the acrylate and derivatives thereof serving as reactive monomers can be acrylic acid, methyl acrylate, dimethylamino ethyl acrylate, diethylamino ethyl acrylate, ethyl acrylate, n-propyl acrylate, isopropyl acrylate, n-butyl acrylate, isobutyl acrylate, sec-butyl acrylate, t-butyl acrylate, hexyl acrylate, methacrylic acid alkyl ester, (1,6-hexanediol di(meth)acrylate, neopentylglycol di(meth)acrylate, neopentylglycol adipate di (meth) acrylate), neopentylglycol di(meth)acrylate hydroxypivalate, dicyclopentadienyl di(meth)acrylate, allylated cyclohexyl di(meth)acrylate, isocyanurate di(meth)acrylate, trimethylol propane tri(meth)acrylate, dipentaerythritol tri(meth)acrylate, propionic acid dipentaerythritol tri(meth)acrylate, pentaerythritol tri(meth)acrylate, tri (acryloxyethyl) isocyanurate, dipentaerythritol penta(meth)acrylate, dipentaerythritol hex(meth)acrylate or derivatives substituted optionally by at least one fluorine atom, alkyl, or alkyloxy group of the above.

According to another aspect of the present invention, the acrylate and derivatives thereof can be acrylate monomers according to formula (I), as follows. 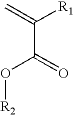
wherein
R₁ can be a hydrogen atom, a fluorine atom, a halogen atom, cyano group, saturated or unsaturated alkyl group, amino group, cycloalkyl group, heterocycloalkyl group, polycyclic alkyl group, aryl group, heteroaryl group, alkylaryl group, or arylalkyl group, wherein the saturated or unsaturated alkyl group can be straight or branched and has 1 to 12 carbon atoms.
R₂ can be a hydrogen atom, saturated or unsaturated alkyl group, cycloalkyl group, heterocycloalkyl group, polycyclic alkyl group, adamantyl group, aryl group, heteroaryl group, alkylaryl group, or arylalkyl group, wherein the saturated or unsaturated alkyl group can be straight or branched and has 1 to 12 carbon atoms.

In addition, at least one hydrogen atom bonded to the carbon atom of the acrylate monomers according to formula (I) can be substituted optionally by a fluorine atom, a halogen atom, cyano group, —R″, CO₂H, —CO₂R″, —R″CO₂H, —COR″, —R″CN, —CONH₂, —CONHR″, —CONR″₂, —OCOR″, or —OR″, wherein R″ can be a saturated or unsaturated alkyl group having 1 to 12 carbon atoms, thioalkyl group, alkynyloxy group, heterocycloalkyl group, alkoxy group, ester group, alkenyl group, alkynylene group, alkenyloxy group, heterocycloalkyl group, aryl group, alkylaryl group, heteroaryl group, arylalkyl group, or combinations thereof. Moreover, at least one hydrogen atom bonded to the carbon atom of R″ can be substituted optionally by a fluorine atom, or halogen atom, when R″ has hydrogen atom bonded to the carbon.

In the present invention, the norbornene and derivatives thereof serving as reactive monomers can be norbornene monomers according to formula (II), as follows. 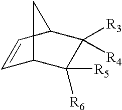
wherein
R₃, R₄, R₅, and R₆ can be the same or different and a hydrogen atom, a fluorine atom, a halogen atom, cyano group, saturated or unsaturated alkyl group, amino group, cycloalkyl group, heterocycloalkyl group, polycyclic alkyl group, aryl group, heteroaryl group, alkylaryl group, or arylalkyl group, wherein the saturated or unsaturated alkyl group can be straight or branched and has 1 to 12 carbon atoms. In addition, at least one hydrogen atom bonded to the carbon atom of the norbornene monomers according to formula (II) can be substituted optionally by a fluorine atom, a halogen atom, cyano group, —R″, —CO₂H, —CO₂R″, —R″CO₂H, —COR″, —R″CN, —CONH₂, —CONHR″, —CONR″₂, —OCOR″, or —OR″, wherein the R″ can be a saturated or unsaturated alkyl group having 1 to 12 carbon atoms, thioalkyl group, alkynyloxy group, heterocycloalkyl group, alkoxy group, ester group, alkenyl group, alkynylene group, alkenyloxy group, heterocycloalkyl group, aryl group, alkylaryl group, heteroaryl group, arylalkyl group, or combinations thereof. Moreover, at least one hydrogen atom bonded to the carbon atom of the R″ can be substituted optionally by a fluorine atom, or halogen atom, when R″ has hydrogen atom bonded to the carbon.

According to the present invention, the at least one initiator employed is an agent, such as peroxide initiators or azo initiators, which generates, upon activation, free radical species through decomposition, and can be 2,2′-azobis(2-cyano-2-butane), dimethyl 2,2′-azobis(methyl isobutyrate), 4,4′-azobis(4-cyanopentanoic acid), 4,4′-azobis(4-cyanopentan-1-ol), 1,1′-azobis(cyclohexanecarbonitrile), 2-(t-butylazo)-2-cyanopropane, 2,2′-azobis[2-methyl-(N)-(1,1)-bis(hydroxymethyl)-2-hydroxyethyl]propionamide, 2,2′-azobis[2-methyl-N-hydroxyethyl)]propionamide, 2,2′-azobis(N,N′-dimethyleneisobutyramidine)dihydrochloride, 2,2′-azobis(2-amidinopropane)dihydrochloride, 2,2′-azobis(N,N′-dimethyleneisobutyramine), 2,2′-azobis(2-methyl-N-[1,1-bis(hydroxymethyl)-2-hydroxyethyl]propionamide, 2,2′-azobis(2-methyl-N-[1,1-bis(hydroxymethyl)ethyl]propionamide), 2,2′-azobis[2-methyl-N-(2-hydroxyethyl)propionamide], 2,2′-azobis(isobutyramide)dihydrate, 2,2′-azobis(2,2,4-trimethylpentane), 2,2′-azobis(2-methylpropane), dilauroyl peroxide, tertiary amyl peroxides, tertiary amyl peroxydicarbonates, t-butyl peroxyacetate, t-butyl peroxybenzoate, t-butyl peroxyoctoate, t-butyl peroxyneodecanoate, t-butylperoxy isobutyrate, t-amyl peroxypivalate, t-butyl peroxypivalate, di-isopropyl peroxydicarbonate, dicyclohexyl peroxydicarbonate, dicumyl peroxide, dibenzoyl peroxide, potassium peroxydisulfate, ammonium peroxydisulfate, di-tert butyl peroxide, di-t-butyl hyponitrite, dicumyl hyponitrite or combinations thereof.

In the present invention, the at least one chain transfer reagent can be reversible addition-fragmentation chain transfer reagent (RAFT reagent) according to the according to formula (III), as follows. 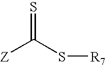
wherein
Z can be a hydrogen atom, a fluorine atom, a halogen atom, cyano group, saturated or unsaturated alkyl group, amino group, cycloalkyl group, heterocycloalkyl group, polycyclic alkyl group, aryl group, heteroaryl group, alkylaryl group, arylalkyl group, heteroalkylaryl group, —CO₂H, —CO₂R″, —R″CO₂H, —COR″, —CONH₂, —CONHR″, —CONR″₂, —OCOR″, —OR″, —SR″, —NR″₂, or —POR″₂, wherein R″ can be a saturated or unsaturated alkyl group having 1 to 12 carbon atoms, thioalkyl group, alkynyloxy group, heterocycloalkyl group, alkoxy group, ester group, alkenyl group, alkynylene group, alkenyloxy group, heterocycloalkyl group, aryl group, alkylaryl group, heteroaryl group, arylalkyl group, or combinations thereof. Furthermore, at least one hydrogen atom bonded to the carbon atom of Z can be substituted optionally by a fluorine atom, or halogen atom, when Z has hydrogen atom bonded to the carbon.
R₇ can be a hydrogen atom, a fluorine atom, a halogen atom, cyano group, saturated or unsaturated alkyl group, amino group, cycloalkyl group, heterocycloalkyl group, polycyclic alkyl group, aryl group, heteroaryl group, alkylaryl group, or arylalkyl group, wherein the saturated or unsaturated alkyl group can be straight or branched and has 1 to 12 carbon atoms.

In addition, at least one hydrogen atom bonded to the carbon atom of the RAFT reagent according to formula (III) can be substituted optionally by a fluorine atom, a halogen atom, cyano group, —R″, —CO₂H, —CO₂R″, —R″CO₂H, —COR″, —R″CN, —CONH₂, —CONHR″, —CONR″₂, —OCOR″, or —OR″, wherein R″ can be a saturated or unsaturated alkyl group having 1 to 12 carbon atoms, thioalkyl group, alkynyloxy group, heterocycloalkyl group, alkoxy group, ester group, alkenyl group, alkynylene group, alkenyloxy group, heterocycloalkyl group, aryl group, alkylaryl group, heteroaryl group, arylalkyl group, or combinations thereof. Moreover, at least one hydrogen atom bonded to the carbon atom of R″ can be substituted optionally by a fluorine atom, or halogen atom, when R″ has hydrogen atom bonded to the carbon.

Preferably, the RAFT reagent according to formula (III) can be further suitable for use in the present invention through according to formula (IV), as follows. 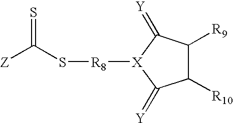
wherein
Z is defined as formula (III);
R₈ can be a saturated or unsaturated alkyl group having 1 to 12 carbon atoms, thioalkyl group, alkoxy group, alkenyl group, alkynylene group, alkenyloxy group, alkynyloxy group, or combinations thereof;
R₉ and R₁₀ are the same or different and defined as R₇, wherein R₉ and R₁₀ may are jointly constructed of cycloalkyl group, heterocycloalkyl group, cycloalkenyl group, alkylaryl group, heteroaryl group, polycyclic alkyl group, or arylalkyl group;
X can be N or —CH; and
Y can be O or S. In addition, at least one hydrogen atom bonded to the carbon atom of the RAFT reagent according to formula (IV) can be substituted optionally by a fluorine atom, a halogen atom, cyano group, —R″, —CO₂H, —CO₂R″, —R″CO₂H, —COR″, —R″CN, —CONH₂, —CONHR″, —CONR″₂, —OCOR″, or —OR″, wherein R″ can be a saturated or unsaturated alkyl group having 1 to 12 carbon atoms, thioalkyl group, alkynyloxy group, heterocycloalkyl group, alkoxy group, ester group, alkenyl group, alkynylene group, alkenyloxy group, heterocycloalkyl group, aryl group, alkylaryl group, heteroaryl group, arylalkyl group, or combinations thereof. Moreover, at least one hydrogen atom bonded to the carbon atom of R″ can be substituted optionally by a fluorine atom, or halogen atom, when R″ has hydrogen atom bonded to the carbon.

Moreover, the RAFT reagent can be 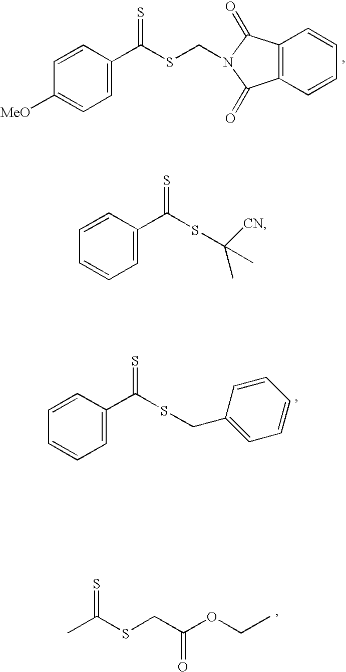
or combinations thereof, wherein at least one hydrogen atom bonded to the carbon atom of the above RAFT reagent can be substituted optionally by a fluorine atom, a halogen atom, cyano group, —R″, —CO₂H, —CO₂R″, —R″CO₂H, —COR″, —R″CN, —CONH₂, —CONHR″, —CONR″₂, —OCOR″,or —OR″, wherein R″ can be a saturated or unsaturated alkyl group having 1 to 12 carbon atoms, thioalkyl group, alkynyloxy group, heterocycloalkyl group, alkoxy group, ester group, alkenyl group, alkynylene group, alkenyloxy group, heterocycloalkyl group, aryl group, alkylaryl group, heteroaryl group, arylalkyl group, or combinations thereof. Moreover, at least one hydrogen atom bonded to the carbon atom of R″ can be substituted optionally by a fluorine atom, or halogen atom, when R″ has hydrogen atom bonded to the carbon.

The following embodiments are intended to clarify the invention more fully without limiting the scope of the claims, since numerous modifications and variations will be apparent to those skilled in this art.

Resin Synthesis

The following discloses the compound structures, names and symbols for the compounds in the embodiments and comparative embodiments of the present invention for better understanding.

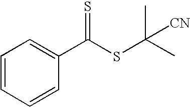

RAFT1: dithiobenzoic acid cyano-dimethyl-methyl ester

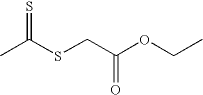

RAFT2: thioacetyl sulfanyl-acetic acid ethyl ester

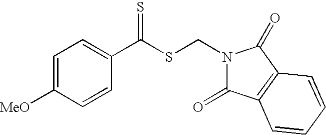

RAFT3: 4-methoxy-dithiobenzoic acid 1,3-dioxo-1,3-dihydro-isoindol-2-ylmethyl ester

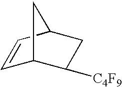

NB1: 5-butyl-bicyclo[2.2.1]hept-2-ene

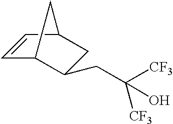

NB2: bicyclo[2.2.1]hept-5-ene-2-(1,1,1-trifluoro-2-trifluoromethylpropan-2-ol

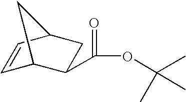

NB3: 2-bicyclo[2.2.1]hept-5-ene-2-carboxylic acid tert-butyl ester

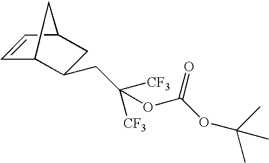

NB4: tert-Butyl 3-{bicyclo[2.2.1]hept-5-ene-2yl}-1,1,1-trifluoro-2-trifluoromethyl-2-propyl carbonate

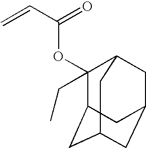

EtAdA: acrylic acid 2-ethyl-adamantan-2-yl ester

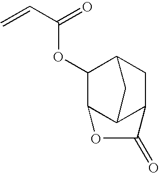

HAdA: acrylic acid 5-oxo-4-oxa-tricyclo[4.2.1.0] non-2-yl ester

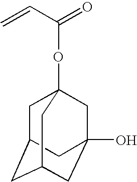

NLA: acrylic acid 3-hydroxy-adamantan-1-yl ester

### First Comparative Example

0.5 g (3.42 mmol) di-tert butyl peroxide (DTBP) was put into a polymerization bottle as an initiator, the bottle gas was displaced with nitrogen and 0.5 g (2.58 mmol) NB3 and 0.5 g (1.34 mmol) NB4 were added. The above mixture were degassed with three freeze-pump-thaw cycles in the closed system to remove oxygen, and then the system was heated to 150° C. and reacted for 3 hours. Next, the unreacted monomers were removed, and the residual was dissolved in toluene. After precipitation with pentane, 0.42 g of polymer product was obtained with average molecular weight of 16150 characterized by gel permeation chromatography (GPC) analysis, with PDI of 1.88.

### Second Comparative Example

20 mg of azobisisobutyronitril (AIBN) was put into a polymerization bottle as an initiator, the bottle gas was displaced with nitrogen. Under nitrogen condition, 3 ml dehydrated ethyl acetate (EA) and monomers, 0.25 g (1.95 mmol) tert-butyl acetate, 0.168 g (1.95 mmol) methyl acrylate and 0.14 g (1.95 mmol) acrylic acid, were added. The above mixture were degassed with three freeze-pump-thaw cycles in the closed system to remove oxygen, and then the system was heated to 60° C. and reacted for 16 hours. After reaction and precipitation with pentane, 0.42 g of polymer product was obtained with average molecular weight of 45165 by gel permeation chromatography (GPC) analysis, with PDI of 2.07.

The above two comparative examples disclose conventional free radical polymerization. The monomers are polymerized by free radical initiators resulting in uncontrollable molecular weight of resin product. Regardless of whether the monomer comprises unsaturated double bond acrylic monomers (second comparative example) or norbornene derivatives, the PDI range is larger, so the performance of the photoresist with the conventional polymerization resin as the main component decreases. The examples of the present invention describe the resin preparation. The polymerization not only uses free radical initiators to polymerize monomers, but also uses the chain transfer reagent to control the free radical polymerization. This polymerization controls the resin's molecular weight precisely to tune resin characteristics, such that the low PDI resins of the present invention are obtained.

### FIRST EXAMPLE

0.0045 g (0.027 mmol) AIBN, as an initiator, and 0.0125 g (0.036 mmol) RAFT3 as a chain transfer reagent were put into a polymerization bottle, the bottle gas was displaced with nitrogen and 1.5 ml dehydrated toluene and monomers, 0.75 ml (5.75 mmol) 85% norbornene and 1.74 g (5.58 mmol) NB1, were added. The above mixture were degassed with three freeze-pump-thaw cycles in the closed system to remove oxygen, the system was heated to 60° C. and reacted 48 hours. After reaction, the solvent was removed by vacuum evaporation and toluene was added. By precipitation with pentane, 0.1 g of polymer product was obtained with average molecular weight of 3610 by gel permeation chromatography (GPC) analysis, with PDI of 1.28.

### SECOND EXAMPLE

0.53 g (3.63 mmol) DTBP, as an initiator, and 0.03 g (0.0873 mmol) RAFT3 as a chain transfer reagent were put into a polymerization bottle, the bottle gas was displaced with nitrogen and 1 g of (3.65 mmol) dehydrated toluene monomers was put into a polymerization bottle. The above mixture were degassed with three freeze-pump-thaw cycles in the closed system to remove oxygen, the system was heated to 145° C. and reacted for 24 hours. After reaction, the solvent was removed and toluene was added. By precipitation with pentane, 0.47 g of polymer product was obtained with average molecular weight of 3699 by gel permeation chromatography (GPC) analysis, with PDI of 1.40.

### THIRD EXAMPLE

4 mg (0.024 mmol) AIBN, as an initiator, and 16.6 g (0.048 mmol) RAFT3 as a chain transfer reagent were put into a polymerization bottle, the bottle gas was displaced with nitrogen. 3 ml dehydrated ethyl acetate and monomers, 0.25 g (1.95 mmol) tert-butyl acetate, 0.168 g (1.95 mmol) methyl acrylate and 0.14 g (1.95 mmol) acrylic acid, were added under nitrogen. The above mixture were degassed with three freeze-pump-thaw cycles in the closed system to remove oxygen, the system was heated to 60° C. and reacted for 16 hours. After reaction and precipitation with pentane, 0.45 g of polymer product was obtained with average molecular weight of 5756 by gel permeation chromatography (GPC) analysis, with PDI of 1.28.

### FOURTH EXAMPLE

4 mg (0.024 mmol) AIBN, as an initiator, and 16.6 g (0.048 mmol) RAFT3 as a chain transfer reagent were put into a polymerization bottle, the bottle gas was displaced with nitrogen and 3 ml dehydrated ethyl acetate and monomers, 0.5 g (3.9 mmol) tert-butyl acetate, 0.168 g (1.95 mmol) methyl acrylate and 0.14 g (1.95 mmol) acrylic acid, were added. The above mixture were degassed with three freeze-pump-thaw cycles in the closed system to remove oxygen, the system was heated to 60° C. and reacted for 16 hours. After reaction and precipitation with pentane, 0.7 g of polymer product was obtained with average molecular weight of 10146 by gel permeation chromatography (GPC) analysis, with PDI of 1.26.

### FIFTH EXAMPLE

4 mg (0.024 mmol) AIBN, as an initiator, and 16.6 g (0.048 mmol) RAFT3 as a chain transfer reagent were put into a polymerization bottle, the bottle gas was displaced with nitrogen and 3 ml dehydrated ethyl acetate under nitrogen and monomers, 0.225 g (0.96 mmol) EtAdA, 0.2 g (0.96 mmol) NLA and 0.107 g (0.48 mmol) HAdA, were added. The above mixture were degassed with three freeze-pump-thaw cycles in the closed system to remove oxygen, the system was heated to 60° C. and reacted for 72 hours. After reaction and precipitation with pentane, 0.46 g of polymer product was obtained with average molecular weight of 9000 by gel permeation chromatography (GPC) analysis, with PDI of 1.38.

### SIXTH EXAMPLE

6.5 mg (0.04 mmol) AIBN, as an initiator, and 28.2 g (0.16 mmol) RAFT2 as a chain transfer reagent were put into a polymerization bottle. The bottle gas was displaced with nitrogen and 3 ml dehydrated ethyl acetate and monomers, 0.225 g (0.96 mmol) EtAdA, 0.2 g (0.96 mmol) NLA and 0.107 g (0.48 mmol) HAdA, were added under nitrogen. The above mixture were degassed with three freeze-pump-thaw cycles in the closed system to remove oxygen, the system was heated to 60° C. and reacted for 24 hours. After reaction and precipitation with pentane, 0.42 g of polymer product was obtained with average molecular weight of 9300 by gel permeation chromatography (GPC) analysis, with PDI of 1.44.

### SEVENTH EXAMPLE

17.9 mg (0.109 mmol) AIBN, as an initiator, and 50 mg (0.226 mmol) RAFT1 as a chain transfer reagent were put into a polymerization bottle, the bottle gas was displaced with nitrogen and 3 ml dehydrated toluene under nitrogen and monomers, 3.48 g (11.15 mmol) NB1 and 1 ml (11.15 mmol) methyl acrylate, were added. The above mixture were degassed with three freeze-pump-thaw cycles in the closed system to remove oxygen, the system was heated to 60° C. and reacted for 16 hours. After reaction, the solvent was removed and toluene was added. By precipitation with pentane, 0.1 g of polymer product was obtained with average molecular weight of 2409 by gel permeation chromatography (GPC) analysis, with PDI of 1.20.

The components, average molecular weight, and PDI of the resins according to the second comparative example, third example and fourth example are shown in Table 1.

TABLE 1

| | | Chain | monomers | | | | |
|---|---|---|---|---|---|---|---|
| | | transfer | tert- | | | | |
| | Initiator | reagent | butyl | methyl | | Polymer | |
| | AIBN | RAFT3 | acetate | acrylate | acrylic | characteristics | |
| | (mg) | (mg) | (g) | (g) | acid (g) | Mw | PDI |
| second | 20 | 0 | 0.25 | 0.168 | 0.14 | 45165 | 2.07 |
| compar- | | | | | | | |
| ative | | | | | | | |
| example | | | | | | | |
| Third | 4 | 16.6 | 0.25 | 0.168 | 0.14 | 5756 | 1.28 |
| example | | | | | | | |
| fourth | 4 | 16.6 | 0.5 | 0.168 | 0.14 | 10146 | 1.26 |
| example | | | | | | | |

The polymerizations with chain transfer reagent (as described in the third and fourth examples) have lower PDI and molecular average weight than those without (as described in the second comparative example).

Therefore, the resin with lowered PDI of the present invention comprises monomers polymerized by free radicals, further using the chain transfer reagent to control the free radical polymerization, to obtain resin with lowered PDI.

In addition, due to the chain transfer reagent addition, the resin with lowered PDI preparation of the present invention can be used for polymerization of norbornene monomers, and copolymerization of norbornene monomers and acrylate monomers.

Furthermore, the resin with lowered PDI of the present invention can be tuned easily to improve photoresist performance.

While the invention has been described by way of example and in terms of the preferred examples, it is to be understood that the invention is not limited to the disclosed examples. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A resin with lowered polydispersity index, comprising the reaction product of the following reactants:
at least two different acrylate monomers;
at least one initiator; and
at least one chain transfer reagent,
wherein the reaction product has a polydispersity index of 1.5 or less.

2. The resin as claimed in claim 1, wherein the acrylate monomer has a formula (I), of. 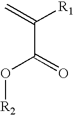
wherein
R₁ is a hydrogen atom, a fluorine atom, a halogen atom, cyano group, saturated or unsaturated alkyl group, amino group, cycloalkyl group, heterocycloalkyl group, polycyclic alkyl group, aryl group, heteroaryl group, arylalkyl group, or alkylaryl group, wherein the saturated or unsaturated alkyl group is straight or branched and has 1 to 12 carbon atoms;
R₂ is a hydrogen atom, saturated or unsaturated alkyl group, cycloalkyl group, heterocycloalkyl group, polycyclic alkyl group, adamantyl group, aryl group, heteroaryl group, arylalkyl group, or alkylaryl group, wherein the saturated or unsaturated alkyl group is straight or branched and has 1 to 12 carbon atoms; and
optionally at least one hydrogen atom bonded to the carbon atom of the acrylate monomer according to formula (I) is substituted by a fluorine atom, a halogen atom, cyano group, —R″, —CO₂H, —CO₂R″, —R″CO₂H, —COR″, —R″CN, —CONH₂, —CONHR″, —CONR″₂, —OCOR″, or —OR″, wherein R″ is saturated or unsaturated alkyl group having 1 to 12 carbon atoms, thioalkyl group, alkynyloxy group, heterocycloalkyl group, alkoxy group, ester group, alkenyl group, alkynylene group, alkenyloxy group, heterocycloalkyl group, aryl group, arylalkyl group, alkylaryl group, heteroaryl group, or combinations thereof, provided that when R″ has hydrogen atom bonded to the carbon, optionally at least one hydrogen atom bonded to the carbon atom of R″ is substituted by a fluorine atom, or halogen atom.

3. The resin as claimed in claim 1, wherein the initiator is an agent generating free radical species through decomposition.

4. The resin as claimed in claim 1, wherein the initiator is peroxide initiators, azo initiators, or combinations thereof.

5. The resin as claimed in claim 1, wherein the chain transfer reagent is a reversible addition-fragmentation chain transfer reagent.

6. The resin as claimed in claim 1, wherein the chain transfer reagent is a reversible addition-fragmentation chain transfer reagent according to formula (III), of 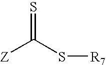
wherein
Z is a hydrogen atom, a fluorine atom, a halogen atom, cyano group, saturated or unsaturated alkyl group, amino group, cycloalkyl group, heterocycloalkyl group, polycyclic alkyl group, aryl group, heteroaryl group, arylalkyl group, alkylaryl group, heteroalkylaryl group, —CO₂H, —CO₂R″, —R″CO₂H, —COR″, —CONH₂, —CONHR″, —CONR″₂, —OCOR″, —OR″, —SR″, —NR″₂, or —POR″₂, wherein R″ is saturated or unsaturated alkyl group having 1 to 12 carbon atoms, thioalkyl group, alkynyloxy group, heterocycloalkyl group, alkoxy group, ester group, alkenyl group, alkynylene group, alkenyloxy group, heterocycloalkyl group, aryl group, arylalkyl group, alkylaryl group, heteroaryl group, or combinations thereof;
R₇ is a hydrogen atom, a fluorine atom, a halogen atom, cyano group, saturated or unsaturated alkyl group, amino group, cycloalkyl group, heterocycloalkyl group, polycyclic alkyl group, aryl group, heteroaryl group, arylalkyl group, or alkylaryl group, wherein the saturated or unsaturated alkyl group is straight or branched and has 1 to 12 carbon atoms; and
optionally at least one hydrogen atom bonded to the carbon atom of the RAFT reagent according to formula (III) is substituted by a fluorine atom, a halogen atom, cyano group, —R″, —CO₂H, —CO₂R″, —R″CO₂H, —COR″, —R″CN, —CONH₂, —CONHR″, —CONR″₂, —OCOR″, or —OR″, wherein R″ is saturated or unsaturated alkyl group having 1 to 12 carbon atoms, thioalkyl group, alkynyloxy group, heterocycloalkyl group, alkoxy group, ester group, alkenyl group, alkynylene group, alkenyloxy group, heterocycloalkyl group, aryl group, arylalkyl group, alkylaryl group, heteroaryl group, or combinations thereof, provided that when R″ has hydrogen atom bonded to the carbon, optionally at least one hydrogen atom bonded to the carbon atom of R″ is substituted by a fluorine atom, or halogen atom.

7. The resin as claimed in claim 1, wherein the chain transfer reagent is a reversible addition-fragmentation chain transfer reagent according to formula (IV), of 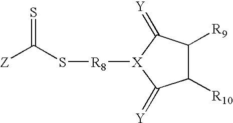
wherein
Z is a hydrogen atom, a fluorine atom, a halogen atom, cyano group, saturated or unsaturated alkyl group, amino group, cycloalkyl group, heterocycloalkyl group, polycyclic alkyl group, aryl group, heteroaryl group, arylalkyl group, alkylaryl group, heteroalkylaryl group, —CO₂H, —CO₂R″, —R″CO₂H, —COR″, —CONH₂, —CONHR″, —CONR″₂, —OCOR″, —OR″, —SR″, —NR″₂, or —POR″₂, wherein R″ is saturated or unsaturated alkyl group having 1 to 12 carbon atoms, thioalkyl group, alkynyloxy group, heterocycloalkyl group, alkoxy group, ester group, alkenyl group, alkynylene group, alkenyloxy group, heterocycloalkyl group, aryl group, arylalkyl group, alkylaryl group, heteroaryl group, or combinations thereof;
R₈ is saturated or unsaturated alkyl group having 1 to 12 carbon atoms, thioalkyl group, alkoxy group, alkenyl group, alkynylene group, alkenyloxy group, alkynyloxy group, or combinations thereof;
R₉ and R₁₀ are the same or different and are a hydrogen atom, a fluorine atom, a halogen atom, cyano group, saturated or unsaturated alkyl group, amino group, cycloalkyl group, heterocycloalkyl group, polycyclic alkyl group, aryl group, heteroaryl group, arylalkyl group, or alkylaryl group, wherein the saturated or unsaturated alkyl group is straight or branched and has 1 to 12 carbon atoms;
X is N or —CH;
Y is O or S; and
optionally at least one hydrogen atom bonded to the carbon atom of the RAFT reagent according to formula (IV) is substituted by a fluorine atom, a halogen atom, cyano group, —R″, —CO₂H, —CO₂R″, —R″CO₂H, —COR″, —R″CN, —CONH₂, —CONHR″, —CONR″₂, —OCOR″, or —OR″, wherein R″ is saturated or unsaturated alkyl group having 1 to 12 carbon atoms, thioalkyl group, alkynyloxy group, heterocycloalkyl group, alkoxy group, ester group, alkenyl group, alkynylene group, alkenyloxy group, heterocycloalkyl group, aryl group, arylalkyl group, alkylaryl group, heteroaryl group, or combinations thereof, provided that when R″ has a hydrogen atom bonded to the carbon, optionally at least one hydrogen atom bonded to the carbon atom of R″ is substituted by a fluorine atom, or halogen atom.

8. The resin as claimed in claim 7, wherein the R₉ and R₁₀ are jointly constructed of cycloalkyl group, heterocycloalkyl group, cycloalkenyl group, arylalkyl group, alkylaryl group, heteroaryl group, or polycyclic alkyl group.

9. The resin as claimed in claim 1, wherein the chain transfer reagent is 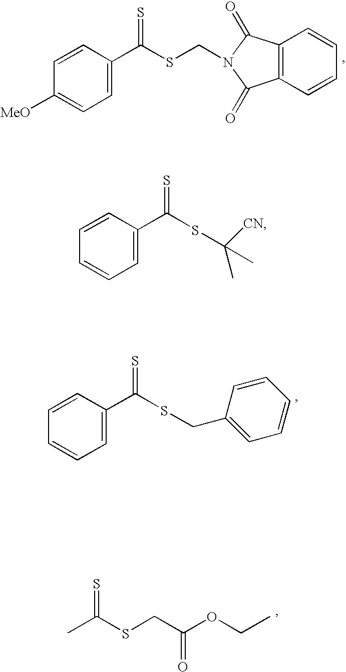
or combinations thereof,
wherein
optionally at least one hydrogen atom bonded to the carbon atom of the chain transfer reagent is substituted by a fluorine atom, a halogen atom, cyano group, —R″, —CO₂H, —CO₂R″, —R″CO₂H, —COR″, —R″CN, —CONH₂, —CONHR″, —CONR″₂, —OCOR″,or —OR″, wherein R″ is saturated or unsaturated alkyl group having 1 to 12 carbon atoms, thioalkyl group, alkynyloxy group, heterocycloalkyl group, alkoxy group, ester group, alkenyl group, alkynylene group, alkenyloxy group, heterocycloalkyl group, aryl group, arylalkyl group, alkylaryl group, heteroaryl group, or combinations thereof, provided that when R″ has hydrogen atom bonded to the carbon, optionally at least one hydrogen atom bonded to the carbon atom of R″ is substituted by a fluorine atom, or halogen atom.

10. The resin as claimed in claim 1, wherein the reaction product has an average molecular weight from 2000 to 30000.

11. A resin with lowered polydispersity index, comprising the reaction product of the following reactants:
at least one norbornene monomer in a ratio from 1 ppm to 100 wt %;
at least one acrylate monomer, in a ratio from 0 wt % to 99.99999 wt %, based on the weight of at least one norbornene monomer and at least one acrylate monomer;
at least one initiator; and
at least one chain transfer reagent,
wherein the reaction product has a polydispersity index of 1.5 or less.

12. The resin as claimed in claim 11, wherein the acrylate monomer has a formula (I), of: 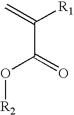
wherein
R₁ is a hydrogen atom, a fluorine atom, a halogen atom, cyano group, saturated or unsaturated alkyl group, amino group, cycloalkyl group, heterocycloalkyl group, polycyclic alkyl group, aryl group, heteroaryl group, arylalkyl group, or alkylaryl group, wherein the saturated or unsaturated alkyl group is straight or branched and has 1 to 12 carbon atoms;
R₂ is a hydrogen atom, saturated or unsaturated alkyl group, cycloalkyl group, heterocycloalkyl group, polycyclic alkyl group, adamantyl group, aryl group, heteroaryl group, arylalkyl group, or alkylaryl group, wherein the saturated or unsaturated alkyl group is straight or branched and has 1 to 12 carbon atoms; and
optionally at least one hydrogen atom bonded to the carbon atom of the acrylate monomer according to formula (I) is substituted by a fluorine atom, a halogen atom, cyano group, —R″, —CO₂H, —CO₂R″, —R″CO₂H, —COR″, —R″CN, —CONH₂, —CONHR″, —CONR″₂, —OCOR″, or —OR″, wherein R″ is saturated or unsaturated alkyl group having 1 to 12 carbon atoms, thioalkyl group, alkynyloxy group, heterocycloalkyl group, alkoxy group, ester group, alkenyl group, alkynylene group, alkenyloxy group, heterocycloalkyl group, aryl group, arylalkyl group, alkylaryl group, heteroaryl group, or combinations thereof, provided that when R″ has hydrogen atom bonded to the carbon, optionally at least one hydrogen atom bonded to the carbon atom of R″ is substituted by a fluorine atom, or halogen atom.

13. The resin as claimed in claim 11, wherein the norbornene monomer has a formula (II), of: 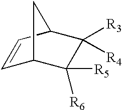
wherein
R₃, R₄, R₅, and R₆ are the same or different and are a hydrogen atom, a fluorine atom, a halogen atom, cyano group, saturated or unsaturated alkyl group, amino group, cycloalkyl group, heterocycloalkyl group, polycyclic alkyl group, aryl group, heteroaryl group, arylalkyl group, or alkylaryl group, wherein the saturated or unsaturated alkyl group is straight or branched and has 1 to 12 carbon atoms; and
optionally at least one hydrogen atom bonded to the carbon atom of the norbornene monomer according to formula (II) is substituted by a fluorine atom, a halogen atom, cyano group, —R″, —CO₂H, —CO₂R″, —R″CO₂H, —COR″, —R″CN, —CONH₂, —CONHR″, —CONR″₂, —OCOR″, or —OR″, wherein the R″ is saturated or unsaturated alkyl group having 1 to 12 carbon atoms, thioalkyl group, alkynyloxy group, heterocycloalkyl group, alkoxy group, ester group, alkenyl group, alkynylene group, alkenyloxy group, heterocycloalkyl group, aryl group, arylalkyl group, alkylaryl group, heteroaryl group, or combinations thereof, provided that when R″ has hydrogen atom bonded to the carbon, optionally at least one hydrogen atom bonded to the carbon atom of R″ is substituted by a fluorine atom, or halogen atom.

14. The resin as claimed in claim 11, wherein the initiator is an agent generating free radical species through decomposition.

15. The resin as claimed in claim 11, wherein the initiator is peroxide initiators, azo initiators, or combinations thereof.

16. The resin as claimed in claim 11, wherein the chain transfer reagent is a reversible addition-fragmentation chain transfer reagent.

17. The resin as claimed in claim 11, wherein the chain transfer reagent is a reversible addition-fragmentation chain transfer reagent according to formula (III), of 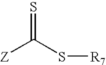
wherein
Z is a hydrogen atom, a fluorine atom, a halogen atom, cyano group, saturated or unsaturated alkyl group, amino group, cycloalkyl group, heterocycloalkyl group, polycyclic alkyl group, aryl group, heteroaryl group, arylalkyl group, alkylaryl group, heteroalkylaryl group, —CO₂H, —CO₂R″, —R″CO₂H, —COR″, —CONH₂, —CONHR″, —CONR″₂, —OCOR″, —OR″, —SR″, —NR″₂, or —POR″₂, wherein R″ is saturated or unsaturated alkyl group having 1 to 12 carbon atoms, thioalkyl group, alkynyloxy group, heterocycloalkyl group, alkoxy group, ester group, alkenyl group, alkynylene group, alkenyloxy group, heterocycloalkyl group, aryl group, arylalkyl group, alkylaryl group, heteroaryl group, or combinations thereof;
R₇ is a hydrogen atom, a fluorine atom, a halogen atom, cyano group, saturated or unsaturated alkyl group, amino group, cycloalkyl group, heterocycloalkyl group, polycyclic alkyl group, aryl group, heteraryl group, arylalkyl group, or alkylaryl group, wherein the saturated or unsaturated alkyl group is straight or branched and has 1 to 12 carbon atoms; and
optionally at least one hydrogen atom bonded to the carbon atom of the RAFT reagent according to formula (III) is substituted by a fluorine atom, a halogen atom, cyano group, —R″, —CO₂H, —CO₂R″, —R″CO₂H, —COR″, —R″CN, —CONH₂, —CONHR″, —CONR″₂, —OCOR″, or —OR″, wherein R″ is saturated or unsaturated alkyl group having 1 to 12 carbon atoms, thioalkyl group, alkynyloxy group, heterocycloalkyl group, alkoxy group, ester group, alkenyl group, alkynylene group, alkenyloxy group, heterocycloalkyl group, aryl group, arylalkyl group, alkylaryl group, heteroaryl group, or combinations thereof, provided that when R″ has hydrogen atom bonded to the carbon, optionally at least one hydrogen atom bonded to the carbon atom of R″ is substituted by a fluorine atom, or halogen atom.

18. The resin as claimed in claim 11, wherein the chain transfer reagent is a reversible addition-fragmentation chain transfer reagent according to formula (IV), of: 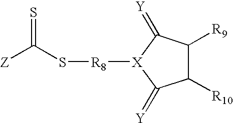
wherein
Z is a hydrogen atom, a fluorine atom, a halogen atom, cyano group, saturated or unsaturated alkyl group, amino group, cycloalkyl group, heterocycloalkyl group, polycyclic alkyl group, aryl group, heteroaryl group, arylalkyl group, alkylaryl group, heteroalkylaryl group, —CO₂H, —CO₂R″, —R″CO₂H, —COR″, —CONH₂, —CONHR″, —CONR″₂, —OCOR″, —OR″, —SR″, —NR″₂, or —POR″₂, wherein R″ is saturated or unsaturated alkyl group having 1 to 12 carbon atoms, thioalkyl group, alkynyloxy group, heterocycloalkyl group, alkoxy group, ester group, alkenyl group, alkynylene group, alkenyloxy group, heterocycloalkyl group, aryl group, arylalkyl group, alkylaryl group,heteroaryl group, or combinations thereof;
R₈ is saturated or unsaturated alkyl group having 1 to 12 carbon atoms, thioalkyl group, alkoxy group, alkenyl group, alkynylene group, alkenyloxy group, alkynyloxy group, or combinations thereof;
R₉ and R₁₀ are the same or different and selected from a hydrogen atom, a fluorine atom, a halogen atom, cyano group, saturated or unsaturated alkyl group, amino group, cycloalkyl group, heterocycloalkyl group, polycyclic alkyl group, aryl group, heteroaryl group, arylalkyl group, or alkylaryl group, wherein the saturated or unsaturated alkyl group is straight or branched and has 1 to 12 carbon atoms;
X is N or —CH;
Y is O or S; and
optionally at least one hydrogen atom bonded to the carbon atom of the RAFT reagent according to formula (IV) is substituted by a fluorine atom, a halogen atom, cyano group, —R″, —CO₂H, —CO₂R″, —R″CO₂H, —COR″, —R″CN, —CONH₂, —CONHR″, —CONR″₂, —OCOR″, or —OR″, wherein R″ is saturated or unsaturated alkyl group having 1 to 12 carbon atoms, thioalkyl group, alkynyloxy group, heterocycloalkyl group, alkoxy group, ester group, alkenyl group, alkynylene group, alkenyloxy group, heterocycloalkyl group, aryl group, arylalkyl group, alkylaryl group, heteroaryl group, or combinations thereof, provided that when R″ has hydrogen atom bonded to the carbon, optionally at least one hydrogen atom bonded to the carbon atom of R″ is substituted by a fluorine atom, or halogen atom.

19. The resin as claimed in claim 18, wherein the R₉ and R₁₀ are jointly constructed of cycloalkyl group, heterocycloalkyl group, cycloalkenyl group, arylalkyl group, alkylaryl group, heteroaryl group, or polycyclic alkyl group.

20. The resin as claimed in claim 11, wherein the chain transfer reagent is 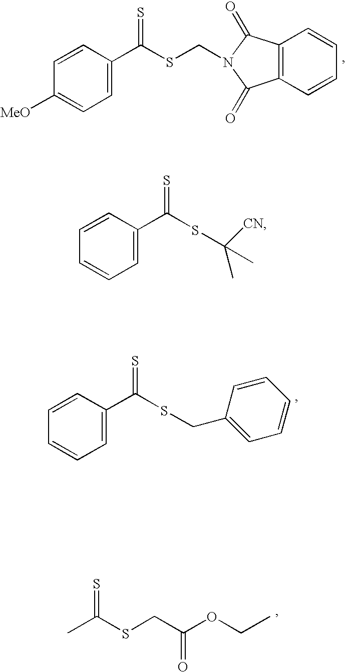
or combinations thereof,
wherein
optionally at least one hydrogen atom bonded to the carbon atom of the chain transfer reagent is substituted by a fluorine atom, a halogen atom, cyano group, —R″, —CO₂H, —CO₂R″, —R″CO₂H, —COR″, —R″CN, —CONH₂, —CONHR″, —CONR″₂, —OCOR″, or —OR″, wherein R″ is saturated or unsaturated alkyl group having 1 to 12 carbon atoms, thioalky group, alkynyloxy group, heterocycloalkyl group, alkoxy group, ester group, alkenyl group, alkynylene group, alkenyloxy group, heterocycloalkyl group, aryl group, arylalkyl group, alkylaryl group, heteroaryl group, or combinations thereof, provided that when R″ has hydrogen atom bonded to the carbon, optionally at least one hydrogen atom bonded to the carbon atom of R″ is substituted by a fluorine atom, or halogen atom.

21. The resin as claimed in claim 11, wherein the reaction product has an average molecular weight from 2000 to 30000.

22. A preparation of a resin with lowered PDI, comprising:
reacting at least one reactive monomer, at least one initiator, and at least one chain transfer reagent undergoing polymerization to obtain a resin with lowered PDI,
wherein the reactive monomer comprises acrylate monomer, norbornene monomer, or combinations thereof.

23. The preparation as claimed in claim 22, wherein the acrylate monomer has a formula (I), of. 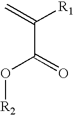
wherein
R₁ is a hydrogen atom, a fluorine atom, a halogen atom, cyano group, saturated or unsaturated alkyl group, amino group, cycloalkyl group, heterocycloalkyl group, polycyclic alkyl group, aryl group, heteroaryl group, arylalkyl group, or alkylaryl group, wherein the saturated or unsaturated alkyl group is straight or branched and has 1 to 12 carbon atoms;
R₂ is a hydrogen atom, saturated or unsaturated alkyl group, cycloalkyl group, heterocycloalkyl group, polycyclic alkyl group, adamantyl group, aryl group, heteroaryl group, alkylaryl group, or arylalkyl group, wherein the saturated or unsaturated alkyl group is straight or branched and has 1 to 12 carbon atoms; and
optionally at least one hydrogen atom bonded to the carbon atom of the acrylate monomer according to formula (I) is substituted by a fluorine atom, a halogen atom, cyano group, —R″, —CO₂H, —CO₂R″, —R″CO₂H, —COR″, —R″CN, —CONH₂, —CONHR″, —CONR″₂, —OCOR″, or —OR″, wherein R″ is saturated or unsaturated alkyl group having 1 to 12 carbon atoms, thioalkyl group, alkynyloxy group, heterocycloalkyl group, alkoxy group, ester group, alkenyl group, alkynylene group, alkenyloxy group, heterocycloalkyl group, aryl group, arylalkyl group, alkylaryl group, heteroaryl group, or combinations thereof, provided that when R″ has hydrogen atom bonded to the carbon, optionally at least one hydrogen atom bonded to the carbon atom of R″ is substituted by a fluorine atom, or halogen atom.

24. The preparation as claimed in claim 22, wherein the initiator is an agent generating free radical species through decomposition.

25. The preparation as claimed in claim 22, wherein the initiator is peroxide initiator, azo initiators, or combinations thereof.

26. The preparation as claimed in claim 22, wherein the chain transfer reagent is a reversible addition-fragmentation chain transfer reagent.

27. The preparation as claimed in claim 22, wherein the chain transfer reagent is a reversible addition-fragmentation chain transfer reagent according to formula (III), of 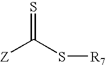
wherein
Z is a hydrogen atom, a fluorine atom, a halogen atom, cyano group, saturated or unsaturated alkyl group, amino group, cycloalkyl group, heterocycloalkyl group, polycyclic alkyl group, aryl group, heteroaryl group, alkylaryl group, arylalkyl group, heteroalkylaryl group, —CO₂H, —CO₂R″, —R″CO₂H, —COR″, —CONH₂, —CONHR″, —CONR″₂, —OCOR″, —OR″, —SR″, —NR″₂, or —POR″₂, wherein R″ is saturated or unsaturated alkyl group having 1 to 12 carbon atoms, thioalkyl group, alkynyloxy group, heterocycloalkyl group, alkoxy group, ester group, alkenyl group, alkynylene group, alkenyloxy group, heterocycloalkyl group, aryl group, group,heteroaryl group, arylalkyl group, or combinations thereof;
R₇ is a hydrogen atom, a fluorine atom, a halogen atom, cyano group, saturated or unsaturated alkyl group, amino group, cycloalkyl group, heterocycloalkyl group, polycyclic alkyl group, aryl group, heteroaryl group, alkylaryl group, or arylalkyl group, wherein the saturated or unsaturated alkyl group is straight or branched and has 1 to 12 carbon atoms; and
optionally at least one hydrogen atom bonded to the carbon atom of the RAFT reagent according to formula (III) is substituted by a fluorine atom, a halogen atom, cyano group, —R″, —CO₂H, —CO₂R″, —R″CO₂H, —COR″, —R″CN, —CONH₂, —CONHR″, —CONR″₂, —OCOR″, or —OR″, wherein R″ is saturated or unsaturated alkyl group having 1 to 12 carbon atoms, thioalkyl group, alkynyloxy group, heterocycloalkyl group, alkoxy group, ester group, alkenyl group, alkynylene group, alkenyloxy group, heterocycloalkyl group, aryl group, alkylaryl group, heteroaryl group, arylalkyl group, or combinations thereof, provided that when R″ has hydrogen atom bonded to the carbon, optionally at least one hydrogen atom bonded to the carbon atom of R″ is substituted by a fluorine atom, or halogen atom.

28. The preparation as claimed in claim 22, wherein the chain transfer reagent is a reversible addition-fragmentation chain transfer reagent according to formula (IV), of: 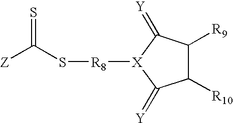
wherein
Z is a hydrogen atom, a fluorine atom, a halogen atom, cyano group, saturated or unsaturated alkyl group, amino group, cycloalkyl group, heterocycloalkyl group, polycyclic alkyl group, aryl group, heteroaryl group, alkylaryl group, arylalkyl group, heteroalkylaryl group, —CO₂H, —CO₂R″, —R″CO₂H, —COR″, —CONH₂, —CONHR″, —CONR″₂, —OCOR″, —OR″, —SR″, —NR″₂, or —POR″₂, wherein R″ is saturated or unsaturated alkyl group having 1 to 12 carbon atoms, thioalkyl group, alkynyloxy group, heterocycloalkyl group, alkoxy group, ester group, alkenyl group, alkynylene group, alkenyloxy group, heterocycloalkyl group, aryl group, alkylaryl group, heteroaryl group, arylalkyl group, or combinations thereof;
R₈ is saturated or unsaturated alkyl group having 1 to 12 carbon atoms, thioalkyl group, alkoxy group, alkenyl group, alkynylene group, alkenyloxy group, alkynyloxy group, or combinations thereof;
R₉ and R₁₀ are the same or different and selected from a hydrogen atom, a fluorine atom, a halogen atom, cyano group, saturated or unsaturated alkyl group, amino group, cycloalkyl group, heterocycloalkyl group, polycyclic alkyl group, aryl group, heteroaryl group, alkylaryl group, or arylalkyl group, wherein the saturated or unsaturated alkyl group is straight or branched and has 1 to 12 carbon atoms;
X is N or —CH;
Y is O or S; and
optionally at least one hydrogen atom bonded to the carbon atom of the RAFT reagent according to formula (IV) is substituted by a fluorine atom, a halogen atom, cyano group, —R″, —CO₂H, —CO₂R″, —R″CO₂H, —COR″, —R″CN, —CONH₂, —CONHR″, —CONR″₂, —OCOR″, or —OR″, wherein R″ is saturated or unsaturated alkyl group having 1 to 12 carbon atoms, thioalkyl group, alkynyloxy group, heterocycloalkyl group, alkoxy group, ester group, alkenyl group, alkynylene group, alkenyloxy group, heterocycloalkyl group, aryl group, alkylaryl group, heteroaryl group, arylalkyl group, or combinations thereof, provided that when R″ has hydrogen atom bonded to the carbon, optionally at least one hydrogen atom bonded to the carbon atom of R″ is substituted by a fluorine atom, or halogen atom.

29. The preparation as claimed in claim 28, wherein the R₉ and R₁₀ are jointly constructed of cycloalkyl group, heterocycloalkyl group, cycloalkenyl group, alkylaryl group, arylalkyl group, heteroaryl group, or polycyclic alkyl group.

30. The preparation as claimed in claim 22, wherein the chain transfer reagent is 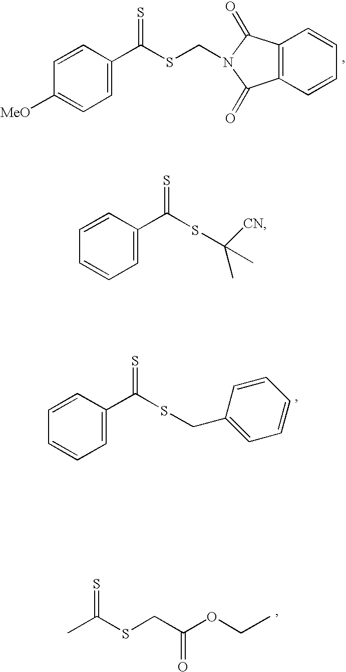
or combinations thereof,
wherein
optionally at least one hydrogen atom bonded to the carbon atom of the chain transfer reagent is substituted by a fluorine atom, a halogen atom, cyano group, —R″, —CO₂H, —CO₂R″, —R″CO₂H, —COR″, —R″CN, —CONH₂, —CONHR″, —CONR″₂, —OCOR″, or —OR″, wherein R″ is saturated or unsaturated alkyl group having 1 to 12 carbon atoms, thioalkyl group, alkynyloxy group, heterocycloalkyl group, alkoxy group, ester group, alkenyl group, alkynylene group, alkenyloxy group, heterocycloalkyl group, aryl group, alkylaryl group, heteroaryl group, arylalkyl group, or combinations thereof, provided that when R″ has hydrogen atom bonded to the carbon, optionally at least one hydrogen atom bonded to the carbon atom of R″ is substituted by a fluorine atom, or halogen atom.

31. The preparation as claimed in claim 22, wherein the reaction product has an average molecular weight from 2000 to 30000.
